(19) United States
(12) Patent Application Publication
(10) Pub. No.: US 2002/0126695 A1
(43) Pub. Date: Sep. 12, 2002

(54) Concatenation signal communication system

(76) Inventor: Hiroshi Yoshida, Kawasaki (JP)

Correspondence Address: Katten Muchin Zavis Rosenman, 575 Madison Avenue, New York, NY, 10022-2585, US

(21) Appl. No.: 10/133,996

(22) Filed: Apr. 24, 2002

Related U.S. Application Data
(63) Continuation of application No. PCT/JP99/05919, filed on Oct. 26, 1999.

(51) Int. Cl. H04J 3/16

(52) U.S. Cl. 370/465

(57) ABSTRACT

In a concatenation signal communication system for transmitting concatenation state information indicating a composition of a concatenation signal to a frame and for receiving a concatenation signal based on the information, a transmission side inserts a concatenation type identifier into a predetermined position of a frame header portion and notifies a concatenation type of a concatenation signal to a reception side. The reception side compares the concatenation type identifier with the preset concatenation type to be received, and determines whether the concatenation signal is accurately received. Alternatively, the reception side preliminarily stores the concatenation type identifier indicating the concatenation signal composition to be received, stores the concatenation state information included at the frame header portion for each channel, and determines whether the concatenation signal is normally received based on the concatenation type identifier and concatenation state information of a channel related to a received concatenation signal within the concatenation state information.

### BACKGROUND OF THE INVENTION

### 1. Field of the Invention

The present invention relates to a concatenation signal communication system, and in particular to a concatenation signal communication system for transmitting concatenation state information indicating a composition of a concatenation signal to a frame and for receiving a concatenation signal based on the information.

When a signal larger than an STS1 signal (channel), that is a minimum unit of a transmission signal, is transmitted in a SONET/SDH synchronous communication system for example, a concatenation signal in which a plurality of STS1 signals are concatenated or interconnected is composed for the transmission. In order to accurately transmit this concatenation signal, it is required to transmit the composition from a transmission side to a reception side.

2. Description of the Related Art

FIG. 5 shows a composition (format or pattern) of STS3 (STM1), STS12 (STM4), and STS48 (STM16) synchronous transmission frames in the SONET (SDH) standard.

These frames have a two-dimensional byte (time slot) array format of 9 rows×{270×M (bytes)} columns, where the value of M is “1” in the STS3 (STM1) synchronous transmission frame, “4” in the STS12 (STM4) synchronous transmission frame, or “16” in the STS48 (STM16) synchronous transmission frame.

Head 9 rows×{9×M (bytes)} columns of a synchronous transmission frame 40 is composed of a Section OverHead (SOH) portion (Regenerator SOH (RSOH) portion in SDH) 41 of the 1st-3rd rows, a Line OverHead (LOH) portion (Multiplex SOH (MSOH) portion) 42 of the 5th-9th rows, and an AU pointer (Administrative Unit Pointer (AU PTR), hereinafter, occasionally abbreviated as pointer) portion 43 of the 4th row. 9 rows×{261×M (bytes)} columns following these head 9 rows×{9×M (bytes)} columns is a payload portion 44 for accommodating multiplexed information.

The SOH portions 41 are used for a maintenance operation between relaying apparatuses, or between a relaying apparatus and a transmitting terminal station apparatus (section layer). The LOH portions 42 are used for a maintenance operation between the transmitting terminal station apparatuses.

The pointer portion 43 has a function of indicating a difference between a time phase of the synchronous transmission frame 40 and a time phase of a multiplexed information frame accommodated in the payload portion 44 as address position differences of the time slots, and is composed of 3 kinds of bytes H1, H2, and H3.

FIGS. 6A-6C respectively show compositions of the pointer portions 43 for the STS3, STS12, and STS48 synchronous transmission frames. The pointer portions 43 of the STS3, STS12, and STS48 synchronous transmission frames are respectively composed of 3 bytes, 12 bytes, and 48 bytes for the H1, H2, and H3 byte portions. The first 1 byte of the H1, H2, and H3 byte portions, the second 1 byte of the H1, H2, and H3 byte portions, . . . , and the last 1 byte of the H1, H2, and H3 byte portions respectively form a single pointer, and designate a head position and the like of 3×M multiplexed information frames.

FIG. 7 shows a code format when the H1, H2, and H3 bytes are combined.

The 1st-4th four bits of the H1 byte portion are New Data Flags (NDF) called N bits. When the NDF=“0110”, it indicates that there is no change in a pointer value. When the NDF=“1001”, it indicates that there is a change in a pointer value.

The 5th and 6th two bits of the H1 byte portion are called S bits and indicate an AU type, where only the value of “10” is prescribed therefor at present.

The 7th-8th bits of the HI byte portion and the 1st-8th bits of the H2 byte portion, or the total of 10 bits indicate a “pointer value”, which is a binary number in the range of 0-782. When the pointer value=“0” for example, a head byte of the multiplexed information frame is inserted into the byte of the payload portion immediately after the H3 byte portion.

In addition, address Nos. 0, 1, 2, . . . , 782 are assigned to the payload portions 44 of the STS3, STS12, and STS48 synchronous transmission frames from the next byte of the last H3 byte portion of the pointer portion 43 respectively for every 3, 12, and 48 bytes.

The 7th bit of the HI byte portion and the 1st, 3rd, 5th, and 7th bits of the H2 byte portion are called I bits. When a frequency adjustment is performed by a positive stuff, the I bits are inverted and transmitted. The 8th bit of the H1 byte portion and the 2nd, 4th, 6th, and 8th bits of the H2 byte portion are called D bits. When the frequency adjustment is performed by a negative stuff, the D bits are inverted for the transmission.

A reception side determines whether or not the I bits are inverted based on majority rule. When they are found to be inverted, the positive stuff is executed. Similarly, the D bit inversion is determined based on majority rule. When they are found to be inverted, the negative stuff is executed.

The H3 byte portion is one for the negative stuff. In case of the pointer value=“0” and a negative stuff, for example, the head byte of the multiplexed information frame is inserted into the H3 byte portion.

It is to be noted that the execution times of the positive and the negative stuff is prescribed one time per 4 frames at most.

In the SONET standard for example, a concatenation signal is prescribed. This concatenation signal is a large signal in which a plurality of channels are bundled with a minimum unit STS1 signal being made a 1CH (channel). STS3C, STS12C, and STS48C type concatenation signals have already been internationally standardized in which every 3CH's, 12CH's, and 48CH's of the STS1 signal are respectively bundled.

FIG. 8 shows a format of the H1, H2, and H3 byte portions when the concatenation signal is composed in the STS3 synchronous transmission frame. A head pair of the H1 and H2 byte portions composes a head pointer, which has the same composition as that described in FIG. 7.

Two pairs of the remaining H1 and H2 byte portions compose slave pointers (H1, H2) having concatenation indication (Y, 1*), where Y=“1001xx11” (xx is “00” in SONET, or is an arbitrary value in SDH), and 1*=“11111111”. Namely, the concatenation indication (Y, 1*) is occasionally referred to as a slave pointer.

When the H1, H2, and H3 byte portions are set, as shown in FIG. 8, in the STS12 synchronous transmission frame, the head byte of the STS1 signal (frame) of the first multiplexed information is inserted into the address position designated by the H1 and H2 byte portions of the head pointer. The head byte of the 2nd STS1 signal is inserted into the position delayed by 4 bytes from the pointer position. The head byte of the 3rd STS1 signal is inserted into the position further delayed by 4 bytes. Moreover, the 2nd and the following bytes of the frames are sequentially inserted by a byte interleave method.

Thus, three multiplexed information frames are bundled into a single concatenation signal frame to be transmitted. The reception side can recognize that a plurality of frames are bundled and transmitted as a concatenation signal by referring to the pointer portion, and can efficiently perform e.g. a cross-connect operation.

As for the STS3 and STS48 synchronous transmission frames, the reception side similarly receives the concatenation signal based on the pointer portion set on the transmission side.

FIGS. 9A, 9B, 9Ca, and 9Cb respectively show a relationship between a time slot No. TS# and a channel No. CH# designated by the pointers of the H1 and H2 byte portions of the pointer portions in the STS3, STS12, and STS48 synchronous transmission frames.

The pointers of the channel Nos. (time slot Nos.) hatched in FIGS. 9A-9Cb indicate the head pointers and the other pointers indicate the slave pointers.

In the STS1 type concatenation signal (a single STS1 signal is hereby regarded as a concatenation signal) of the STS3 synchronous transmission frame shown in FIG. 9A, the STS1 signal of the independent channel Nos. CH#1-3 is inserted into the time slots TS#1-3, and the head pointers are inserted into the pointers corresponding to the time slots TS#1-3.

Also, in the STS3C type concatenation signal in which the STS1 signals for 3 channels are bundled, the STS1 signal is inserted respectively into the time slots TS#1-3, the head pointer is inserted into the pointer corresponding to the time slot TS#1, and the slave pointers are inserted into the pointers corresponding to the remaining time slots TS#2 and TS#3 to compose the STS3C type concatenation signal of the channel No. CH#1.

In the STS1 signal of the STS12 synchronous transmission frame shown in FIG. 9B, all of the time slots TS#1-12 are independent channels, and the head pointer is inserted into the pointers of all the time slots TS#1-12, so that all of the time slots operate independently.

It is to be noted that the channel Nos. of the STS1 signal inserted into the time slots TS#1, #2, . . . , #12 are respectively prescribed to be CH#1, #4, #7, #10, #2, #5, #8, #11, #3, #6, #9, and #12.

In the STS3C type concatenation signal, the STS1 signal is sequentially inserted respectively into three time slots TS#1, #5, and #9 and three channels of the STS1 signal are made a single channel, so that it is prescribed that the single channel composes the STS3C type concatenation signal of the channel No. CH#1. The slave pointers indicating the connection to the head pointer of the time slot TS#1 are inserted into the pointers of the time slots TS#5 and #9.

Similarly, the STS3C type concatenation signal is prescribed as follows: Within the three time slots TS#2, #6 and #10, the time slots TS#3, #7 and #11, and the time slots TS#4, #8 and #12, the pointers of the time slots TS#2, #3 and #4 are respectively regarded as the head pointers, and the pointers of the time slots TS#6 and #10, the time slots TS#7 and #11, and the time slots TS#8 and #12 are regarded as the slave pointers to compose the STS3C type concatenation signal of the channel Nos. CH#2, CH#3, and CH#4.

It is prohibited that the STS3C type concatenation signal is composed by the combinations of the time slots other than the above-mentioned combination.

In the STS12C type concatenation signal in which the STS1 signal for 12 channels are bundled, the pointer of the time slot TS#1 is made a head pointer whereby the time slots TS#2-#12 follow in synchronization with the time slot TS#1. Namely, the head pointer is set in the pointer of the time slot TS#1, and the slave pointers are set in the pointers of the remaining time slots TS#2-#12 to compose the STS12C type concatenation signal of the channel No. CH#1.

Similarly in the STS48 synchronous transmission frame shown in FIGS. 9Ca and 9Cb, the STS1, STS3C, STS12C and STS48C type concatenation signals are composed.

Thus, there is no indication in the head pointer as to the type (size) of concatenation signal or whether or not it is one for a single STS1 signal. The size of the concatenation signal can be recognized only by the head pointer and the slave pointer following the head pointer.

When a pointer processor (not shown) of a concatenation signal receiving device which receives the STS12 synchronous transmission frame is set to receive the STS12C type concatenation signal for example, it is confirmed that the pointer of the time slot TS#1 is the head pointer, and the pointers of the time slots TS#2-#12 are the slave pointers (Y, 1*), thereby recognizing that the signal of the TS#1-#12 is the STS12C type concatenation signal (see FIG. 9B).

When it is unconfirmed, the pointer processor detects an LOP (Loss Of Pointer) alarm to be indicated.

Hereinafter, the problem of the prior art concatenation signal communication system will be described referring to FIG. 9B.

When the STS3C type concatenation signal (see FIG. 9B) of the channel No.CH#1 is set to be received for example, the pointer processor of each channel in the concatenation signal receiving device which receives the STS12 synchronous transmission frame confirms that the pointer of the time slot TS#1 is the head pointer, and the pointers of the time slots TS#5 and #9 are the slave pointers (concatenation indication), receives the STS3C type concatenation signal of the channel CH1#, and does not make the LOP alarm indication.

Similarly, it is confirmed that the pointers of the time slots TS#2-#4 are the head pointers, and the pointers of the time slots TS#5-#12 are the slave pointers, and the STS3C type concatenation signals of the channels CH#2-#4 are received.

When the STS12C type concatenation signal is inputted to the pointer processor set to receive the STS3C type concatenation signal of the channel No. CH#1, the head pointer is set in the pointer which designates the time slot TS#1, and the slave pointers are set in the pointers which designate the time slots TS#2-#12. Therefore, the condition of the head pointer and the slave pointer of the pointers in the time slots TS#1, #5, and #9 of the STS3C type concatenation signal of the channel CH#1 is held, so that the LOP alarm which should be basically indicated is not indicated.

It is to be noted that when it is set such that the STS3C type concatenation signal of the channel Nos. CH#2-#4 is received, the LOP alarm is indicated because there is no head pointer.

FIGS. 9Ca and 9Cb show a relationship between the time slot No. and its CH No. of the H1, H2, and H3 byte portions of the pointer portion in the STS48 synchronous transmission frame.

FIGS. 10A-10C respectively show a combination of a setting concatenation signal and an input concatenation signal when the LOP is not detected although a concatenation signal whose size is different from the preset size is inputted in the concatenation signal receiving device for receiving the concatenation signal at the STS3, STS12, and STS48 synchronous transmission frames.

FIGS. 11A-11H show a relationship between the time slot No. TS# and the channel No. CH# designated by the pointers of the H1 and H2 byte portions of the pointer portion in an STS192 synchronous transmission frame which will be standardized in the future.

FIG. 12 shows a combination of the setting concatenation signal and the input concatenation signal when the LOP occurs but it can not be detected assuming that the STS192 synchronous transmission frame is transmitted.

### SUMMARY OF THE INVENTION

It is accordingly an object of the present invention to provide a concatenation signal communication system for transmitting concatenation state information indicating a composition of a concatenation signal to a frame and for receiving a concatenation signal based on the information, wherein whether or not a concatenation type (concatenation size) of the received concatenation signal is the same as the concatenation type preset can be accurately determined

(1) In order to achieve the above-mentioned object, a concatenation signal transmitting device according to the present invention comprises: a register for preliminarily storing a concatenation type identifier indicating a composition of a concatenation signal to be transmitted, and an identifier inserter for inserting the concatenation type identifier into a predetermined position at a header portion of a frame.

Namely, a maintenance person or a CPU on a concatenation signal transmitting device side presets a concatenation type identifier for identifying a type (size) of a concatenation signal to be transmitted in a register. An identifier inserter inputs this identifier from the register, and inserts the identifier into a predetermined position of a header portion of a frame to be transmitted, thereby enabling the concatenation type identifier to be set at the header portion.

Thus, as mentioned in the following (2), it becomes possible for the reception side to accurately determine whether or not a concatenation type is identical with the one set on the transmission side.

(2) Also, a concatenation signal receiving device according to the present invention comprises: a register for preliminarily storing a concatenation type identifier indicating a composition of a concatenation signal to be received, an identifier separator for separating a concatenation type identifier inserted into a predetermined position at a header portion of a received frame, and a concatenation determiner for comparing the concatenation type identifier stored in the register with the concatenation type identifier inserted into the predetermined position at the header portion, and for determining whether or not a concatenation signal is normally received.

Namely, an identifier separator of a concatenation signal receiving device separates the concatenation type identifier included in the predetermined position of the header portion of the reception frame transmitted from the concatenation signal transmitting device of e.g. the above-mentioned (1).

A concatenation determiner recognizes the concatenation type of the concatenation signal received based on the separated concatenation type identifier, and compares the concatenation type with the concatenation type, which should be received, preset in the register. When the both concatenation types are coincident with each other, it is determined that the concatenation signal is normally received, otherwise it is determined that the signal is not normally received and produces e.g. an LOP signal.

Thus, it becomes possible to accurately determine whether or not the composition of the received concatenation signal is the same as that of the preset concatenation type.

(3) Also, in the concatenation signal transmitting device of the present invention according to the above-mentioned present invention (1), either a SONET synchronous transmission frame or an SDH synchronous transmission frame may be used as the frame.

(4) Also, in the concatenation signal receiving device of the present invention according to the above-mentioned present invention (2), either a SONET synchronous transmission frame or an SDH synchronous transmission frame may be used as the frame.

Namely, the concatenation type identifier can be included at a header portion of either an SDH synchronous transmission frame or a SONET synchronous transmission frame to be transmitted.

(5) Also, in the concatenation signal transmitting device of the present invention according to the above-mentioned present invention (3), the predetermined position may comprise an H3 byte portion of a pointer portion.

(6) Also, in the concatenation signal receiving device of the present invention according to the above-mentioned present invention (4), the predetermined position may comprise an H3 byte portion of a pointer portion.

SOH portions of the header portions of the SDH and SONET synchronous transmission frames are terminated by a relaying apparatus (REG apparatus). Accordingly, since the concatenation type identifier included in the SOH portion becomes lost in the course of transmission, it is required to copy the concatenation type identifier to the SOH portion of the transmission frame by the relaying apparatus to be transmitted to the next device when the concatenation type identifier is transmitted by the SOH portion.

In addition, an LOH portion is terminated by a multiplexing apparatus. However, it is not prescribed that all of the multiplexing apparatuses have a terminal function of the pointer in the international standard. Accordingly, the concatenation type identifier included in the LOH portion is similarly required to be copied by the multiplexing apparatus.

Therefore, the concatenation type identifier is set in the H3 byte portion of the pointer portion which is not terminated by the relaying apparatus and the multiplexing apparatus to be transmitted.

Thus, it becomes possible to transmit the concatenation type identifier without being terminated by the prior art relaying apparatus or multiplexing apparatus.

(7) Also, the concatenation signal receiving device of the present invention according to the above-mentioned present invention (6) may further comprise a protective circuit for determining that a value of the H3 byte portion is a normal one of the concatenation type identifier only when the H3 byte portion of an identical value consecutive equal to or more than a predetermined number of times is received.

The H3 byte portion has basically a negative stuff action byte, and becomes payload data when the negative stuff is executed. Accordingly, the H3 byte portion can not be used for the concatenation type identification transmission.

However, according to the international standard as mentioned in the above Description of the Related Art, the operation of the negative stuff can not be continuous at the intervals of equal to or less than four frames.

Also, the concatenation type identifier is static information and is not changed when a main signal is consecutively transmitted without errors.

When receiving an H3 byte signal of the identical value consecutive equal to or more than a predetermined number of times (e.g. three times), a protective circuit makes the value the normal concatenation type identifier.

Thus, the payload data when the negative stuff occurs and the concatenation type identifier can be accurately distinguished from each other to be detected.

(8) Also, a concatenation signal receiving device of the present invention comprises: a register for preliminarily storing a concatenation type identifier indicating a composition of a concatenation signal to be received, a concatenation state information separator for separating concatenation state information included at a header portion of a received frame, from the frame, a concatenation state information storage for storing the concatenation state information for each channel, and a concatenation determiner for determining whether or not a concatenation signal is normally received based on the concatenation type identifier and concatenation state information of a channel related to a received concatenation signal within the concatenation state information.

Namely, a register preliminarily stores the concatenation type identifier indicating the composition of the concatenation signal to be received. A concatenation state information separator separates therefrom the concatenation state information included at the header portion of the reception frame to be provided to the concatenation state information storage.

A concatenation determiner determines whether or not the concatenation signal of the concatenation type designated by the concatenation type identifier is received based on the concatenation state information of the channel related to the received concatenation signal within the concatenation state information.

Thus, it becomes possible to accurately determine whether or not the concatenation type of the received concatenation signal is the same as that designated by the concatenation type identifier preset.

(9) Also, in the concatenation signal receiving device of the present invention according to the above-mentioned present invention (8), the frame may comprise either a SONET synchronous transmission frame or an SDH synchronous transmission frame, and the concatenation state information may comprise a head pointer and a concatenation indication based on an H1 and an H2 byte portion in a pointer portion of the frame.

Namely, the concatenation state information can be an indication of the head pointer and the concatenation based on the H1 and H2 byte portions included in the pointer portion either of the SONET synchronous transmission frame or the SDH synchronous transmission frame.

### BRIEF DESCRIPTION OF THE DRAWINGS

FIG. 1 is a block diagram showing an embodiment of a concatenation signal transmitting device according to the present invention;

FIG. 2 is a diagram showing a concatenation type identifier used in a concatenation signal communication system according to the present invention;

FIG. 3 is a block diagram showing an embodiment (1) of a concatenation signal receiving device according to the present invention;

FIG. 4 is a block diagram showing an embodiment (2) of a concatenation signal receiving device according to the present invention;

FIG. 5 is a diagram showing a format of a general SONET/SDH synchronous transmission frame;

FIGS. 6A-6C are diagrams showing formats of a pointer portion in a general SOENT/SDH synchronous transmission frame;

FIG. 7 is a diagram showing a detailed format of a pointer portion in a general SOENT/SDH synchronous transmission frame;

FIG. 8 is a diagram showing a format of concatenation indication of a pointer portion in a general SOENT/SDH synchronous transmission frame;

FIGS. 9A-9Cb are diagrams showing a relationship between a time slot number and a channel number in STS3, STS12, and STS48 synchronous transmission frames of a general SONET;

FIGS. 10A-10C are diagrams showing a combination of a setting concatenation type (size) and an input concatenation type whose LOP is not indicated in STS3, STS12, and STS48 synchronous transmission frames of a general SONET;

FIGS. 11A-11H are diagrams showing a relationship between a time slot number and a channel number in an STS192 synchronous transmission frame of a general SONET; and

FIG. 12 is a diagram showing a combination of a setting concatenation type (size) and an input concatenation type whose LOP is not indicated in an STS192 synchronous transmission frame of a general SONET.

Throughout the figures, like reference numerals indicate like or corresponding components.

### DESCRIPTION OF THE EMBODIMENTS

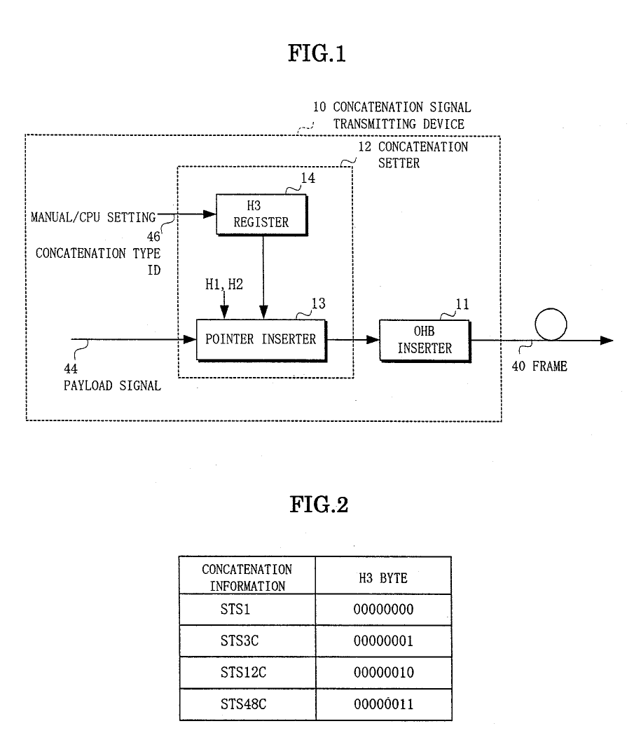

FIG. 1 shows an embodiment of a concatenation signal transmitting device 10 in a concatenation signal communication system according to the present invention.

This transmitting device 10 is composed of a concatenation setter 12 for inputting a concatenation type identifier 46 and a payload signal 44 and an OHB inserter 11 connected to the setter 12 for outputting a frame 40.

The concatenation setter 12 is composed of an H3 register 14 for storing the concatenation type identifier 46 and a pointer inserter 13 for inputting the payload signal 44, H1 and H2 byte signals, and the concatenation type identifier 46 from the H3 register 14.

In operation, a maintenance person or a CPU presets the concatenation type identifier 46 for identifying the concatenation signal when the concatenation signal is transmitted in the H3 register 14.

The pointer inserter 13 firstly secures, in the payload signal 44, a pointer portion 43 composed of H1, H2, and H3 byte portions based on the format shown in FIGS. 6A-6C. The pointer inserter 13 inserts H1 and H2 byte signals into H1 and H2 byte portions, and the concatenation type identifier 46 into an H3 byte portion.

FIG. 2 shows the concatenation type identifier 46 set in the H3 register 14.

Namely, “00000000”, “00000001”, “00000010”, and “00000011” are respectively set as a concatenation type identifier 46 (H3 byte portion) corresponding to the STS1, STS3C, STS12C, and STS48C type concatenation signals.

The OHB inserter 11 transmits the frame 40 of a SONET in which an SOH portion 41 and an LOH portion 42 are further inserted in addition to the received pointer portion 43 and the payload signal 44.

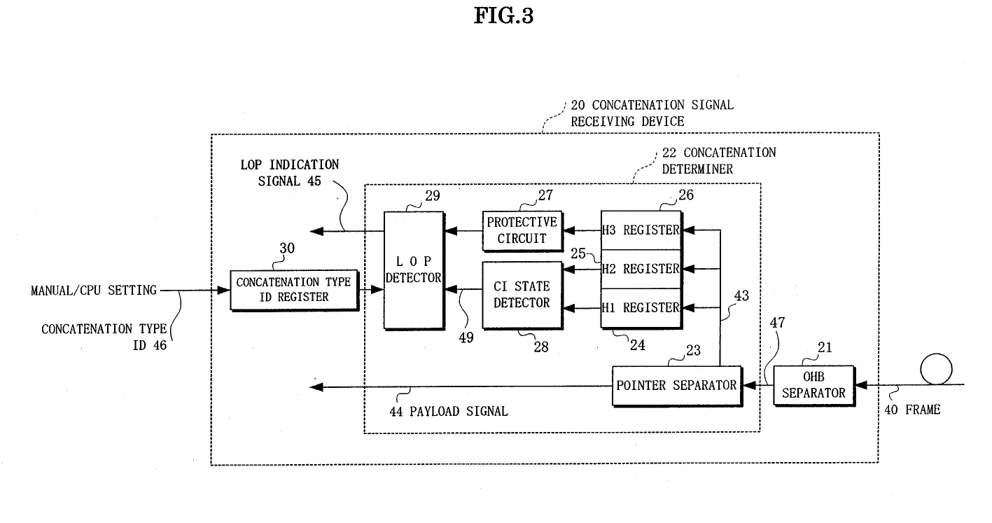

FIG. 3 shows an embodiment (1) of a concatenation signal receiving device 20 for receiving the frame 40 of the SONET from the concatenation signal transmitting device 10 shown in FIG. 1.

This receiving device 20 is composed of a concatenation type identifier register 30 for storing the concatenation type identifier 46, an OHB separator 21 for inputting the frame 40, and a concatenation determiner 22 for inputting a signal 47 from the OHB separator 21 and the concatenation type identifier 46 from the register 30 and for outputting the payload signal 44 and an LOP indication signal 45.

The concatenation determiner 22 is composed of a pointer separator 23 for inputting the signal 47 and for outputting the pointer signal 43 and the payload signal 44, an H1 register 24, an H2 register 25, and an H3 register 26 for respectively storing the H1, H2, and H3 byte signals of the pointer signal 43, a CI state detector 28 for respectively inputting the H1 and H2 byte signals from the H1 and H2 registers 24 and 25, a protective circuit 27 for inputting the H3 byte signal from the H3 register 26, and an LOP detector 29 for inputting the signals from the CI state detector 28 and the protective circuit 27 and the concatenation type identifier 46 from the register 30 and for outputting the LOP indication signal 45.

In operation, the OHB separator 21 provides to the pointer separator 23 the signal 47 that is the frame 40 having separated therefrom the SOH portion 41 and the LOH portion 42. The pointer separator 23 separates the signal 47 into the pointer portion 43 and the payload signal 44 to be outputted.

The registers 24-26 respectively store the H1, H2, H3 byte portions of the pointer portion 43. When the data of the H3 byte portion are identical for 3 frames in series, the protective circuit 27 determines that the data are the concatenation type identifier to be provided to the LOP detector 29.

The CI state detector 28 provides to the LOP detector 29 a concatenation state signal (see FIG. 8: head pointer=(H1, H2), slave pointer=(Y, 1*)) indicating whether the pointer value held in the H1 register 24 and the H2 register 25 per frame 40 is either a head pointer or a slave pointer.

The LOP detector 29 determines whether or not the concatenation state (array of the head pointer and the slave pointer) of the pointer corresponding to the concatenation type identifier 46 from the register 30 is identical with the concatenation state signal 49 from the CI state detector 28. When they are not identical, the LOP detector 29 outputs the LOP indication signal 45 indicating an LOP alarm.

When they are identical, the LOP detector 29 further determines whether or not the concatenation type identifier from the protective circuit 27 is coincident with the concatenation type identifier 46 from the register 30. When they are not coincident, the LOP detector 29 outputs the LOP indication signal 45 indicating the LOP alarm.

It is to be noted that the concatenation type identifier can be inserted into an unused byte of the SOH portion or the LOH portion instead of the H3 byte portion to be transmitted. However in this case, a relaying apparatus or a multiplexing apparatus has to copy a terminated concatenation type identifier 46 to the SOH portion or the LOH portion of the frame to which the identifier 46 is respectively transmitted.

In addition, according to the concatenation signal communication system of the present invention, when the synchronous transmission frame of the SONET/SDH is expanded to the STS192/STM64 synchronous transmission frame, the concatenation signal can be similarly transmitted without mistaking the concatenation type.

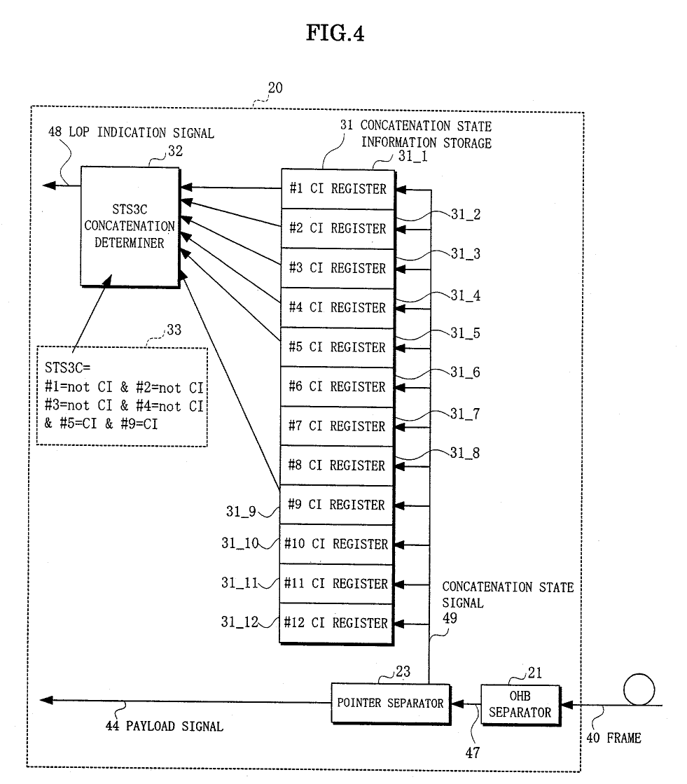

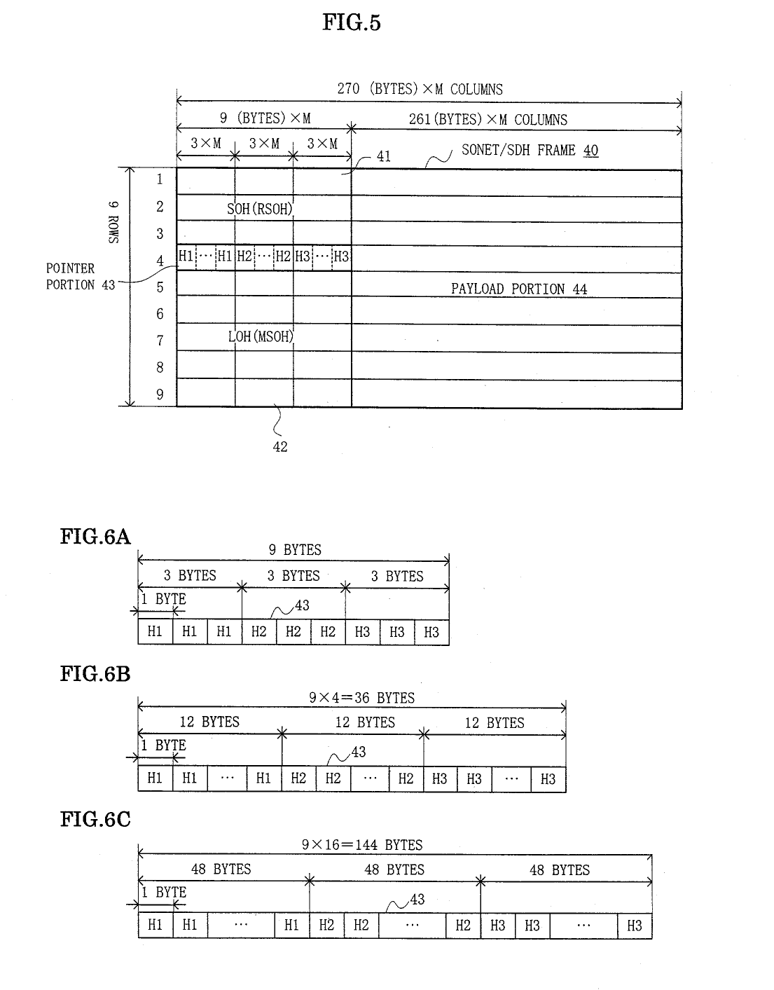

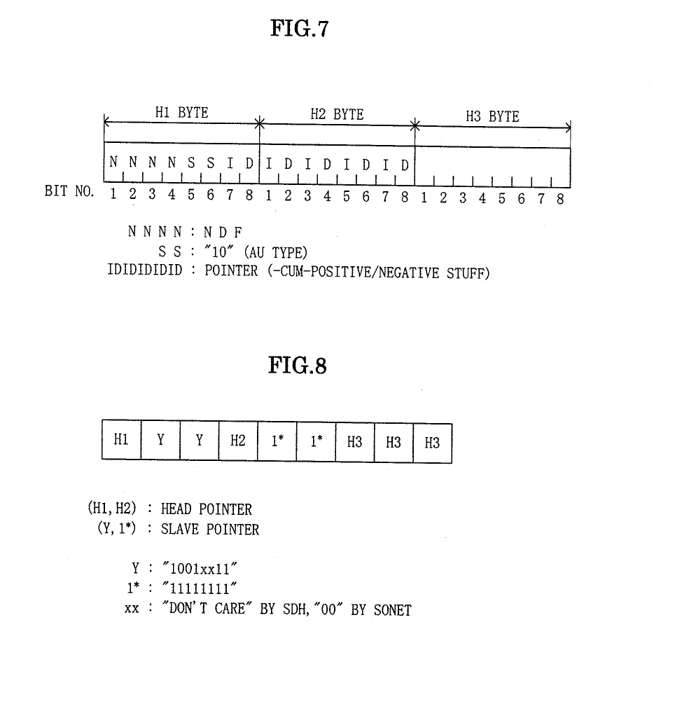

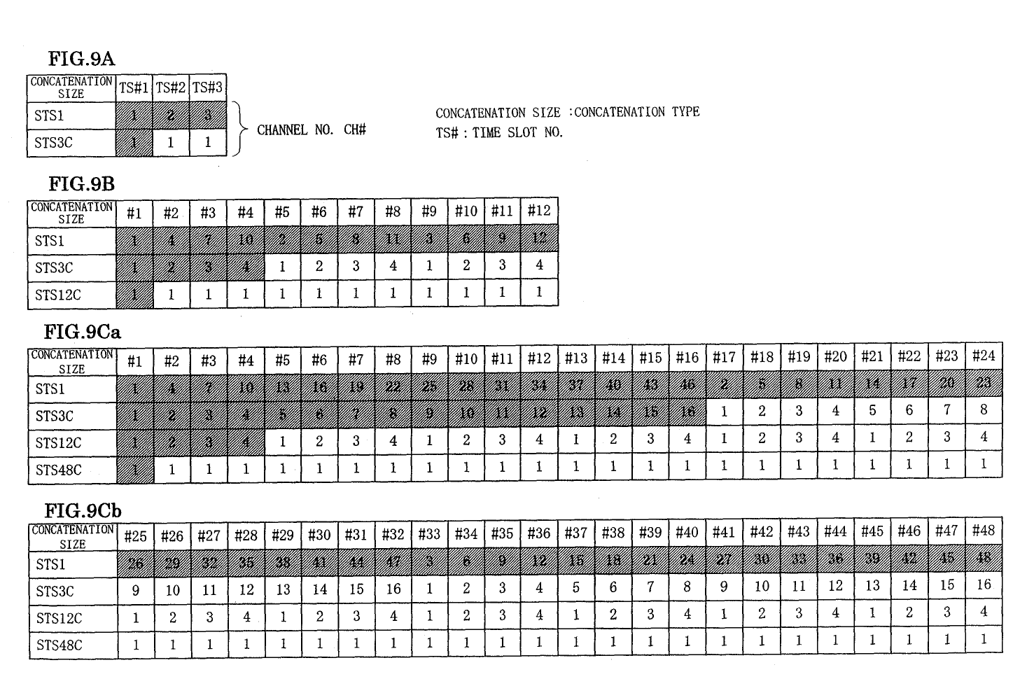

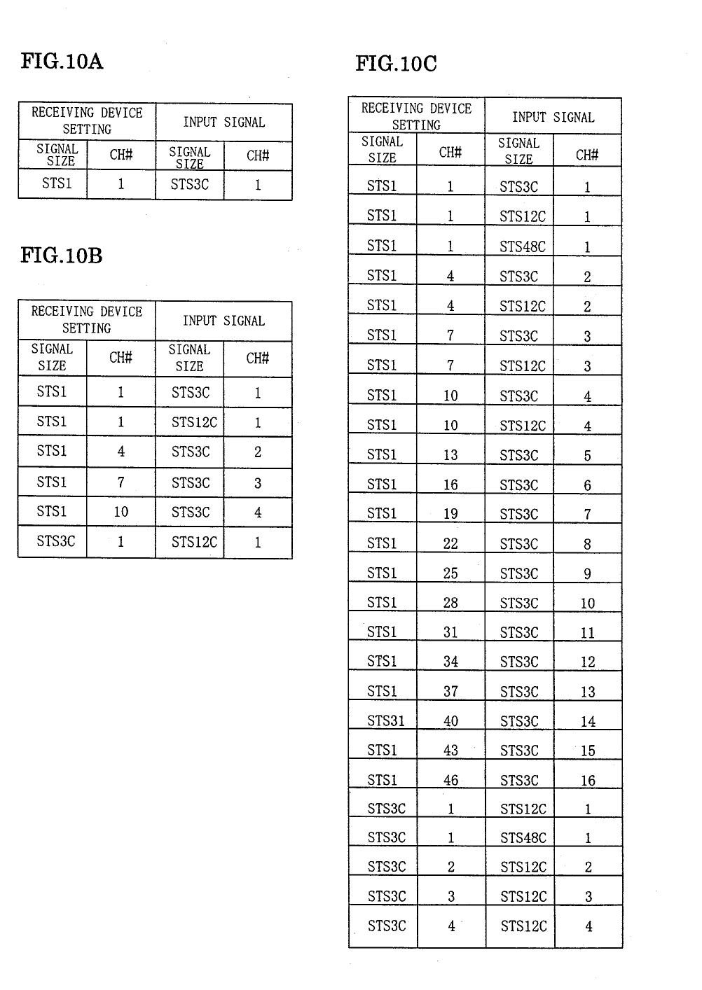

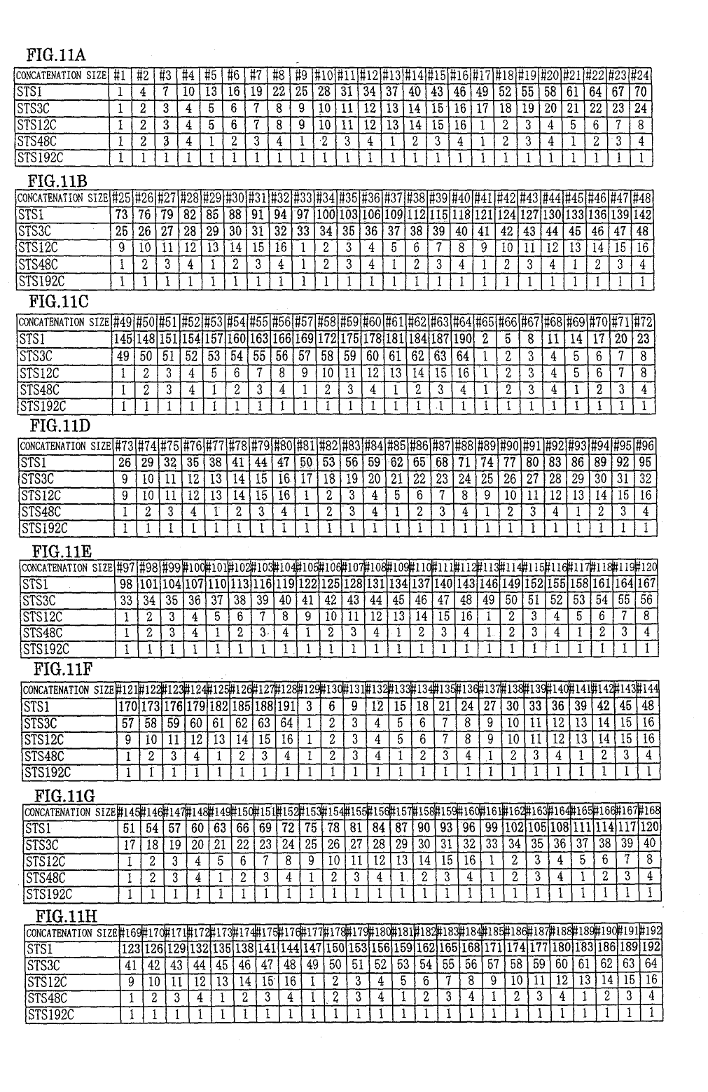

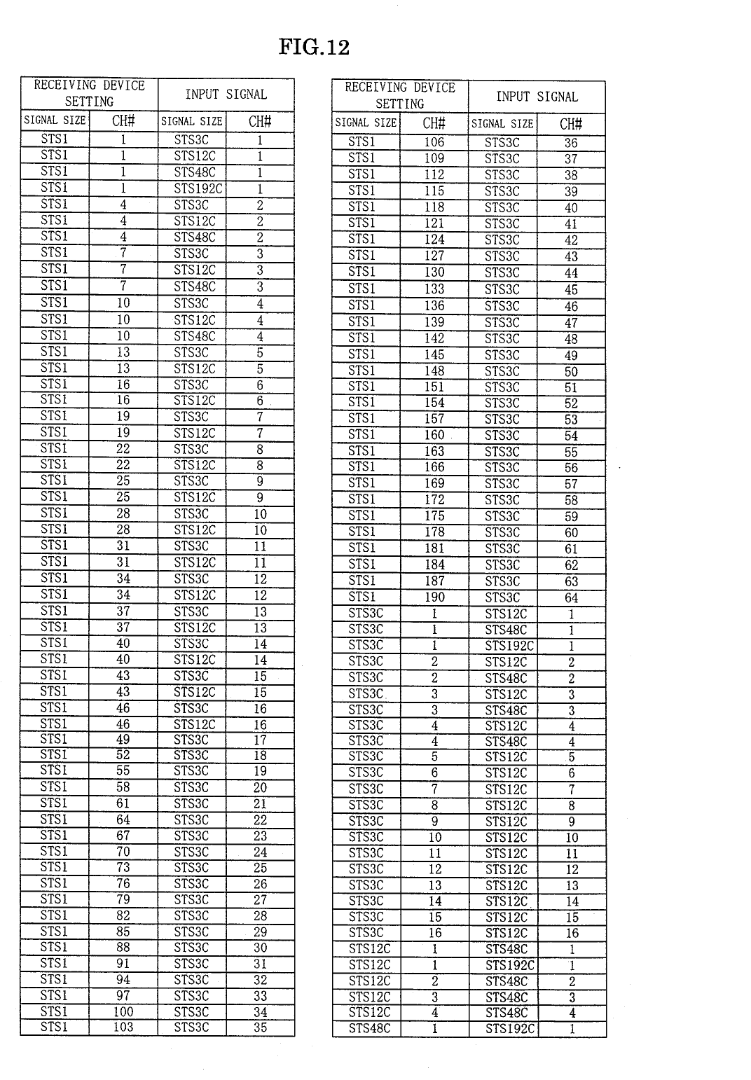

FIG. 4 shows an embodiment (2) of the concatenation signal receiving device 20 for receiving the STS12 synchronous transmission frame of the SONET in the concatenation signal communication system according to the present invention.

This receiving device 20 can be applied to the STS3 synchronous transmission frame from the prior art SONET synchronous communication system, and a transmitting device is not especially limited to the concatenation signal transmitting device 10 shown in FIG. 1 where the concatenation type identifier 46 is inserted into the H3 byte portion.

The receiving device 20 is composed of the OHB separator 21 for inputting the frame 40 and for outputting the signal 47, the pointer separator 23 for receiving the signal 47 and for outputting the concatenation state signal 49 and the payload signal 44, a concatenation state information storage 31 for storing the concatenation state signal 49 as the concatenation state information, and a concatenation determiner 32 for inputting output signals #1-#5 and #9 of the concatenation state information storage 31 and for outputting an LOP indication signal 48.

The concatenation state information storage 31 is composed of CI registers 31_1, . . . , 31_12 for respectively storing the concatenation state signal 49 per channel.

In operation, the OHB separator 21 outputs the signal 47 that is the frame 40 having separated therefrom the SOH portion and the LOH portion. The pointer separator 23 having received this signal 47 outputs the payload signal 44 and the concatenation state signal (concatenation state information) 49 determined based on the pointer signal 43 (not shown) included in the signal 47.

Namely, when the H1 and H2 byte signals per channel of the pointer signal 43 indicate the head pointer (pointer value≧782), the pointer separator 23 outputs “notCI=e.g. “1” When they indicate the slave pointer (pointer value>782), the pointer separator 23 outputs “CI=e.g. “0””.

When the concatenation type of the reception concatenation signal preliminarily designated is STS3C and an arithmetic equation STS3C=((#1=notCI)&(#2=notCI)&(#3=notCI)&(#4=notCI)&(#5=CI) &(#9=CI)) is not true, the concatenation determiner 32 of the STS3C type outputs the LOP indication signal 48 indicating that the received concatenation signal is received with a concatenation type being mistaken.

Thus, when the concatenation signal having different STS3C type from a designated one is received, it becomes possible to reliably detect the LOP.

Similarly, when the STS1 signal is designated, and the STS3C type or the STS12C type concatenation signal is inputted, the arithmetic equation in the concatenation determiner 32 is changed, thereby enabling the LOP to be detected.

Furthermore in the concatenation signal receiving device for receiving the STS3 and STS48 synchronous transmission frames, the input signal and the arithmetic equation of the concatenation determiner 32 are changed, thereby enabling the LOP to be detected.

Also when the frame of the SONET/SDH is extended to the STS192/STM64 synchronous transmission frame, the transmission can be similarly performed without mistaking the concatenation type of the concatenation signal.

As described above, a concatenation signal communication system according to the present invention is arranged such that a transmission side inserts a concatenation type identifier into a predetermined position (e.g. H3 byte) of a header portion of a frame and notifies a concatenation type of a concatenation signal to a reception side, which compares the concatenation type identifier with the preset concatenation type to be received. Therefore, it becomes possible to accurately determine whether or not the concatenation type (concatenation size) of the received concatenation signal is the same as the concatenation type preset.

Also, the concatenation signal communication system is arranged such that the reception side preliminarily stores a concatenation type identifier indicating a composition of a concatenation signal to be received, stores the concatenation state information included at a header portion of a received frame for each channel, and determines whether or not a concatenation signal is normally received based on the concatenation type identifier and concatenation state information of a channel related to a received concatenation signal within the concatenation state information. Therefore, it becomes also possible to accurately determine whether or not the concatenation type (concatenation size) of the received concatenation signal is the same as the concatenation type preset.

What we claim is:

1. A concatenation signal transmitting device comprising:
a register for preliminarily storing a concatenation type identifier indicating a composition of a concatenation signal to be transmitted, and
an identifier inserter for inserting the concatenation type identifier into a predetermined position at a header portion of a frame.

2. A concatenation signal receiving device comprising:
a register for preliminarily storing a concatenation type identifier indicating a composition of a concatenation signal to be received,
an identifier separator for separating a concatenation type identifier inserted into a predetermined position at a header portion of a received frame, and
a concatenation determiner for comparing the concatenation type identifier stored in the register with the concatenation type identifier inserted into the predetermined position at the header portion, and for determining whether or not a concatenation signal is normally received.

3. The concatenation signal transmitting device as claimed in claim 1 wherein the frame comprises either a SONET synchronous transmission frame or an SDH synchronous transmission frame.

4. The concatenation signal receiving device as claimed in claim 2 wherein the frame comprises either a SONET synchronous transmission frame or an SDH synchronous transmission frame.

5. The concatenation signal transmitting device as claimed in claim 3 wherein the predetermined position comprises an H3 byte portion of a pointer portion.

6. The concatenation signal receiving device as claimed in claim 4 wherein the predetermined position comprises an H3 byte portion of a pointer portion.

7. The concatenation signal receiving device as claimed in claim 6, further comprising a protective circuit for determining that a value of the H3 byte portion is a normal one of the concatenation type identifier only when the H3 byte portion of an identical value consecutive equal to or more than a predetermined number of times is received.

8. A concatenation signal receiving device comprising:
a register for preliminarily storing a concatenation type identifier indicating a composition of a concatenation signal to be received,
a concatenation state information separator for separating concatenation state information included at a header portion of a received frame, from the frame,
a concatenation state information storage for storing the concatenation state information for each channel, and
a concatenation determiner for determining whether or not a concatenation signal is normally received based on the concatenation type identifier and concatenation state information of a channel related to a received concatenation signal within the concatenation state information.

9. The concatenation signal receiving device as claimed in claim 8 wherein the frame comprises either a SONET synchronous transmission frame or an SDH synchronous transmission frame, and the concatenation state information comprises a head pointer and a concatenation indication based on an H1 and an H2 byte portion in a pointer portion of the frame.
